(19) United States
(12) Patent Application Publication
(10) Pub. No.: US 2009/0045541 A1
(43) Pub. Date: Feb. 19, 2009

(54) Vehicle steering wheel, vehicle interior trim component or other article with a wood appearance portion

(75) Inventors: Paul I. Lazano, Chihuahua (MX); Juan Chow, Chihuahua (MX); Ricardo Martinez, Chihuahua (MX); Edgardo Sanchez, Chihuahua (MX); Lorenzo Felix, Chihuahua (MX); Luis A. Vargas, Chihuahua (MX); Carlos A. Prieto, Chihuahua (MX); Victor Becerra, Chihuahua (MX); David A. Grilli, Troy, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/891,760

(22) Filed: Aug. 13, 2007

(51) Int. Cl. B29C 45/03; B29C 39/10; B29C 59/00; B44C 1/20; B62D 1/04; G05G 1/10

(52) U.S. Cl. 264/129; 249/56; 264/328.1; 74/552

(57) ABSTRACT

A steering wheel (30) includes a steering wheel armature (32) that includes a rim portion (34). A composite portion (14) is formed by a composite material (52) molded onto the rim portion (34). The composite material (52) comprises a cellulose-based material (56). The composite portion (14) has an outer surface (74) and wood grain impregnations (72) molded in the outer surface. The wood grain impregnations (72) are configured to have a natural wood grain appearance.

### TECHNICAL FIELD

The present invention relates to an article with a wood appearance composite portion and a method for manufacturing the article with the composite portion.

### BACKGROUND OF THE INVENTION

It is often desirable to manufacture products that possess the look and feel of natural wood. Products with the look and feel of natural wood include vehicle components, such as steering wheels, instrumentation bezels, interior trim pieces, shift knobs, spoke covers, and other components with “Class A” surfaces that are visible in a motor vehicle. Manufacturing these components from natural wood can be costly because of the low availability of desirable natural wood material and generally cannot be accomplished with mass production techniques.

### SUMMARY OF THE INVENTION

The present invention relates to a steering wheel that includes a steering wheel armature with a rim portion. A wood composite portion is formed by a wood composite material injection molded onto the rim portion. The wood composite material comprises a thermoplastic or thermoset plastic and/or a cellulose-based material in a resin matrix that can be pre-colored, if desired. The composite portion has an outer surface impregnated with the mold grain design. The design is configured to have a natural wood grain appearance. Alternatively, instead of the wood composite portion, a composite portion could be formed by a composite material, thermoplastic resin or thermoset resin without wood. Also, the composite portion could alternatively be formed by a composite material injection molded onto a spoke portion of the steering wheel.

The present invention also relates to an article forming a class A surface in a vehicle. The article includes a wood composite portion comprising a wood composite material. Alternatively, instead of the wood composite portion, a composite portion could be formed by a composite material without wood. A core portion is insert molded in the composite material. The composite portion has an outer surface with grooves that have been impregnated in through the molding process. The grooves are configured to resemble a natural wood grain. A coating portion comprises at least one layer of wood stain or base coat may comprise a vehicle component 20 with a surface 22 that is disposed on the outer surface of the composite portion. The composite material comprises a cellulose-based material in a percentage by weight such that the composite portion accepts wood stain or base coat. Alternatively, lower levels of cellulose based material can be used in conjunction with a pretreatment such as an adhesion promoter, fluorination, flame, or plasma treatment.

The present invention further relates to a method of manufacturing a steering wheel. The method includes the step of providing a mold having a mold cavity at least partially defined by an inner surface of the mold. The mold cavity is further defined by a wood grain design in the form of grooves on the inner surface of the mold. The method also includes the steps of providing a steering wheel armature and positioning the steering wheel armature in the mold cavity. The method further includes the step of injecting a wood composite material into the mold cavity and onto a rim or spoke portion of the steering wheel armature. The composite material comprises a cellulose-based material in a resin matrix. There is a wood grain design impregnated on an outer surface of the composite material in the configuration resembling a natural wood grain.

### BRIEF DESCRIPTION OF THE DRAWINGS

Further features of the present invention will become apparent to those skilled in the art to which the present invention relates from reading the following description of the invention with reference to the accompanying drawings, in which:

FIG. 1 is schematic view of a portion of an article constructed in accordance with the present invention;

FIG. 2 is a schematic view of a steering wheel in accordance with the present invention;

FIG. 3 is a sectional view taken along line 3-3 of FIG. 2;

FIG. 3A is an enlarged detail view of a portion of FIG. 3;

FIG. 4 is a schematic view of an injection molding apparatus used in the manufacture of the steering wheel of FIG. 2;

FIG. 5 is a sectional view of a mold portion of the injection molding apparatus of FIG. 4;

FIG. 6 is a partial cutaway view of a portion of the mold of FIG. 5;

FIG. 7 is an enlarged sectional view taken generally along line 7-7 of FIG. 6; and

FIG. 8 is an enlarged sectional view taken generally along line 8-8 of FIG. 6.

### DESCRIPTION OF AN EMBODIMENT

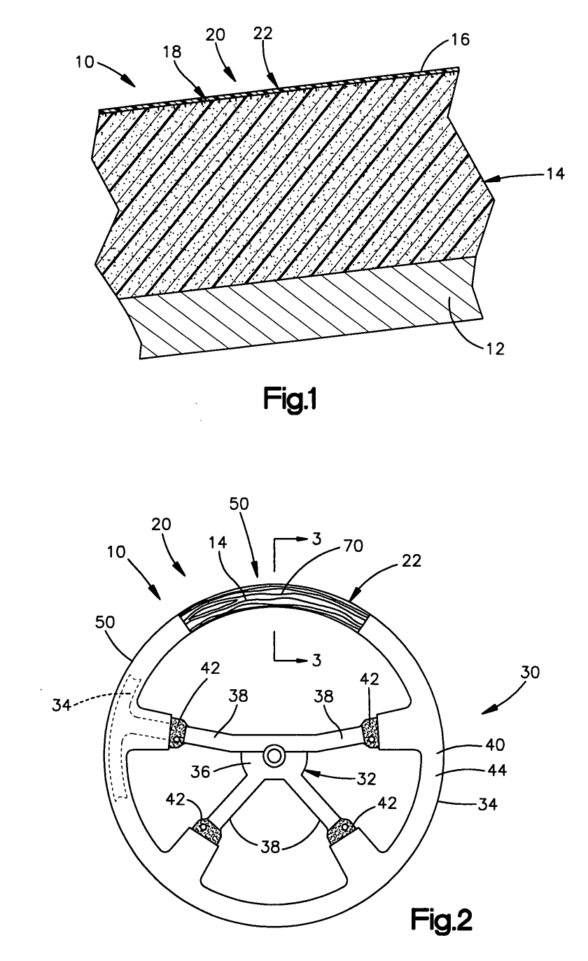

Referring to FIG. 1, the present invention relates to an article 10 that includes a base or core portion 12 and a composite portion 14 molded onto the core portion. The article 10 may also include an outer finish portion 16 coated or otherwise disposed on an outer surface 18 of the composite portion 14. The composite portion 14 and outer finish portion 16, in combination, give the article 10 a natural wood grain appearance.

According to the present invention, the article 10 may comprise a vehicle with a surface component 20 that is a class A surface in a vehicle (not shown). Referring to FIG. 2, the article 10 comprises a vehicle component 20 in the form of a steering wheel 30. The article 10 could comprise an alternative vehicle component (not shown), such as an instrumentation trim piece or bezel, an interior trim piece, a door handle, knob, spoke cover, back cover, or grab handle, or speed control/radio switches.

The steering wheel 30 includes an armature 32 that comprises a rim portion 34 (shown partially in FIG. 2), a hub portion 36, and spoke portions 38. The rim portion 34 is annular in configuration and encircles the hub portion 36. The spoke portions 38 connect the rim portion 34 to the hub portion 36. The hub portion 36 connects the steering wheel armature 32 to a steering column (not shown) of the vehicle. The armature 32 may be made of a metal material, such as steel, magnesium, or aluminum, or specialized engineering plastics. The structure, configuration, appearance, and dimensions of the steering wheel armature 32 can be varied without departing from the scope of the present invention.

Referring to FIG. 2, the rim portion 34 and spoke portions 38 of the steering wheel 30 may have portions covered with padding 40. The padding 40 comprises a substrate 42 disposed on the armature 32 and a skin 44 that covers the substrate. The substrate 42 may, for example, be a plastic resin material molded onto the armature 32 in a suitable manner, such as via insert molding in an injection mold. The plastic resin can include a thermoplastic elastomer, thermoplastic polyolefin, polypropylene, polyvinylchloride, polyurethane, or expanded polypropylene. More commonly, it could be a urethane foam in-mold coated with paint to obtain a Class A surface or subsequently wrapped in leather/synthetic leather.

The skin 44 may be attached to the substrate 42 and may have any desired material construction. For example, the skin 44 may be a natural leather, such as a top grain leather or split grain leather. Optionally, the skin 44 may be a synthetic material, such as a synthetic leather. By “synthetic leather”, it is meant a material that is formed from a coated synthetic fabric or sheet material that simulates the appearance and feel of natural leather. Examples of synthetic leathers that can be used in accordance with the present invention are polymer-coated woven fabrics and polymer-coated non-woven fabrics. Portions of the skin 44 may be sewn together to help secure the skin to the steering wheel 30 and to further enhance the appearance of the steering wheel. Optionally, a padding material (not shown), such as a foam material, may be added between the substrate 42 and skin 44 to provide the steering wheel 30 with a soft feel. Alternatively, the skin 44 may be formed by a self-skinning foam, such as a self-skinning urethane foam.

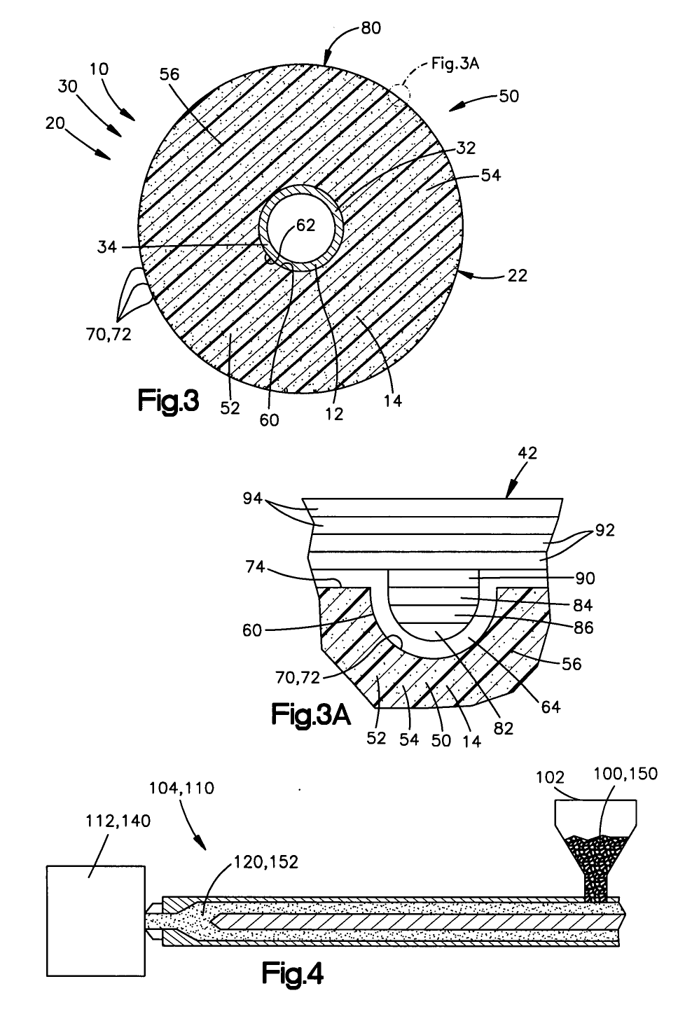

In the embodiment illustrated in FIGS. 2 and 3, the article 10 comprises a wood composite portion 50 of the steering wheel 30 that forms a class A surface 22. In this configuration of the article 10, the core portion 12 comprises an arcuate segment 58 of the rim portion 34 of the armature 32. The composite portion 14 of the article 10 comprises a composite material 52 molded onto the arcuate segment 58 of the rim portion 34 via an injection molding process, such as insert injection molding, as described below. The outer finish portion 16 comprises at least one or more finish layers 80 disposed on the composite material 52, as described below.

Referring to FIG. 3, the composite material 52 includes a continuous portion 54 and a discontinuous portion 56. The discontinuous portion 56 is a cellulose-based material. The discontinuous portion 56 is represented by the specks distributed throughout the composite material 52 in FIGS. 3 and 3A. The continuous portion 54 is a plastic or polymeric material. The continuous portion 54 is represented by the area surrounding the specks in FIGS. 3 and 3A. Referring to FIG. 3, the composite material 52 has an inner surface 60 that bonds or adheres to an outer surface 62 of the rim portion 34. This bond may be promoted or enhanced through preparation of the outer surface 62 of the rim portion 34, as described below.

The material used to form the continuous portion 54 may, for example, comprise thermoplastic and thermosetting materials that may be readily molded onto the rim portion 34 and adhered to the rim portion 34 to resist twisting of the material. However, it should be noted that this material has adequate stiffness to resist twisting without being adhered to the rim portion 34. One material that may be used to form the continuous portion 54 of the composite material 52 is polypropylene. Other examples of materials that may form the continuous portion 54 of the composite material 52 include polyurethane, polyethylene, acrylonitrile-butadiene-styrene, polycarbonate, copolymers of polyethylene and polypropylene, and blends thereof. Other materials well known in the art can also be selected. The addition of wood pulp to the resin yields a composite “wood” wheel. Those skilled in the art will appreciate that it may be desirable to select virgin plastic or polymer materials to form the continuous portion 54.

The cellulose-based material forming the discontinuous portion 56 may comprise a woodmeal, sawdust or wood fiber. The composite material 52 may be provided in the form of resin pellets that include a mixture of the continuous and discontinuous portions 54 and 56, e.g., polypropylene and sawdust. The weight percentage of the discontinuous portion 54, i.e., the cellulose-based fiber material, may be from about 5 to about 75 percent by weight. It is only limited by the ability to injection mold the part. The weight percentage of the cellulose-based fiber material may be selected such that the composite material 52 accepts or absorbs wood stain or a base coat. For example, the weight percentage of the cellulose-based fiber material in the composite material 52 may be from about 50 to about 65 percent by weight.

Optionally, the composite material 52 can include additives to aid in the molding process. For example, coupling agents may be added to help bond the continuous and discontinuous portions 54 and 56 (e.g., the polypropylene and sawdust) of the composite material 52. Lubricants may be added to the composite material 52 to help improve its flow characteristics. Talc may be added to the composite material to help improve its water absorption characteristics. Other examples of additives include known additives for molding thermoplastic and thermosetting resins, such as, colorants, inorganic fillers, such as carbon black and titanium oxide, nucleating agents, such as calcium carbonate and magnesium carbonate, and stabilizers, such as light stabilizers, UV absorbents, Chlorinated polyolefins for enhanced adhesion, and flame retardants. These additives may be employed in amounts conventionally used in the art. The composite material 52 can also include reinforcing materials, such as fiberglass, fabric, or any other natural or synthetic fiber. Such reinforcing materials may serve to increase the strength of the composite material 52 and permit a reduction in the amount of composite material used to form the article 10.

One example of a product that may be used to form the composite portion 14 is JERTECH WPC 702, which is commercially available from J.E.R. Envirotech Ltd. of Delta, British Columbia, Canada. The exact composition of JERTECH WPC 702 is not known. It is, however, known that JERTECH WPC 702 has the following composition:

Wood Flour (Oak): 40-65% by weight

Filler: 0-5% by weight

Polypropylene Homopolymer: 30-60% by weight JERTECH WPC 702 material has a light wood color and a wood smell. Typical values for physical properties exhibited by JERtech™ WPC 702 are as follows:

Density: 1.07 g/cc

Bulk Density: 0.634 kg/liter

Hardness (Izod Impact-unnotched): 5.9 Kj/m²

MFI (Virgin PP): 35 g/10 min (per ASTM D-1238)

Moisture Content: 0.2% ±0.1%

Mechanical Properties

Tensile Modulus: 618,715 psi/4627 MPa (per ASTM D-638)

Stress at Break: 4959 psi/34.2 MPa (per ASTM D-638)

Strain at Break: 2.3% (per ASTM D-638)

Flexural Properties

Flexural Modulus: 551,870 psi/3806 MPa (per ASTM D-790)

Stress at Break: 8932 psi/61.6 MPa (per ASTM D-790)

Strain at Break: 2.7% (per ASTM D-790)

Another example of a product that may be used to form the composite portion 14 is JERTECH WPC 909, which is commercially available from J.E.R. Envirotech Ltd. of Delta, British Columbia, Canada. The exact composition of JERTECH WPC 909 is not known. It is, however, known that JERTECH WPC 909 has the following composition:

Wood Flour (Pine): 40-65% by weight

Modified Polypropylene: 1-5% by weight

Filler: 10-20% by weight

Polypropylene Homopolymer: 30-60% by weight

JERTECH WPC 909 material has a light wood color and a wood smell. Typical values for physical properties exhibited by JERtech™ WPC 909 are as follows:

Density: 1.07 g/cc

Bulk Density: 0.634 kg/liter

Hardness (Izod Impact-unnotched): 5.9 Kj/m²

MFI (Virgin PP): 35 g/10 min (per ASTM D-1238)

Moisture Content: 0.2% ±0.1%

Mechanical Properties

Tensile Modulus: 618,715 psi/4627 MPa (per ASTM D-638)

Stress at Break: 4959 psi/34.2 MPa (per ASTM D-638)

Strain at Break: 2.3% (per ASTM D-638)

Flexural Properties

Flexural Modulus: 551,870 psi/3806 MPa (per ASTM D-790)

Stress at Break: 8932 psi/61.6 MPa (per ASTM D-790)

Strain at Break: 2.7% (per ASTM D-790)

Yet another example of a product that may be used to form the composite portion 14 is known as FASAL F 347/0, which is commercially available from Fasal Wood KEG of Tulln, Austria. The exact composition of FASAL F 347/0 is not known. It is, however, known that FASAL F 347/0 is a wood fiber reinforced polypropylene homopolymer with a fiber content of 50% by weight. Typical values for physical properties exhibited by FASAL F 347/0 are as follows:

Density: 1.07 g/cc (per ISO 1183)

Impact Strength (Charpy): 5.95 Kj/m² (per ISO 179)

Tensile Properties

Tensile Strength: 34.5 N/mm² (per ISO 527)

Tensile Strain: 1.7% (per ISO 527)

Tensile E-modulus: 3750 N/mm² (per ISO 527)

Flexural Properties

Flexural Strength: 54.7 N/mm² (per ISO 178)

Flexural Strain: 2.5% (per ISO 178)

Flexural E-modulus: 3885 N/mm² (per ISO 178)

Referring to FIGS. 2, 3, and 3A, the wood appearance portion 50 includes wood grains 70 arranged in a pattern to provide the appearance of natural wood. According to the present invention, the wood grains 70 are impregnated on the outer surface 74 (FIG. 3A) of the composite material 52 when the composite material is molded onto the arcuate segment 58 of the rim portion 34.

In the embodiment of FIG. 3A, the outer finish portion 16 includes several finish layers 80. The finish layers 80 cover the outer surface 74 of the composite material 52 to help provide the desired natural wood appearance. The finish layers 80 may be formed from a variety of materials.

In the embodiment of FIG. 3A, the finish layers 80 comprises an isolator base coat 64 applied to the outer surface 74. Optionally, an adhesion promoter, fluorination, plasma treatment, or flame treatment can be applied to promote adhesion of the isolator base coat 64. The isolator base coat 64 can provide a color foundation or base undertones for the wood appearance portion 50 and also acts as an adhesion promoter or primer for receiving stains and glazes. The isolator base coat 64 can be colorless or may include a pigment or pigments selected to provide a desired base natural wood color. The isolator base coat can also contain pearlescent pigments and mica to give an undertone luster visible in many stained woods or metallic pigments.

The isolator base coat 64 covers the entire outer surface 74 and wood grain impregnations 72 in the composite material 52. By wood grain “impregnations” in the composite material or a wood grain that is “impregnated” in the composite material, it is meant to refer to cavities, such as impressions, grooves, recesses, slots, or any other deformation in the composite material, configured and arranged so that the composite material resembles natural wood grain. The isolator base coat 64 may have any desired thickness and may be cured by air drying, thermal (heat) curing, or ultraviolet (UV) curing. As an example, the isolator base coat 64 may have a thickness of about 0.5 thousandths of an inch (mils) and may be UV cured.

The finish layers 80 also include first, a glaze coat 82 that completely or partially fills the wood grain impregnations 72 in the composite material 52. The glaze coat 82 may be formed, for example, with an alkyd, polyester, or polyurethane material. The glaze coat 82 may comprise a highly pigmented wood stain for helping to provide the desired color in the impregnated areas for the wood grain appearance portion 50. The glaze coat 82 may, for example, have a thickness of about 0.1-3.0 mils and may be thermal cured, UV cured, or air dried.

The glaze coat 82 may completely fill the wood grain impregnations 72. Alternatively, the glaze coat 82 may partially fill the wood grain impregnations 72 and the finish layers 80 may include a second glaze coat for contrast and depth of image. This alternative is shown in FIG. 3A. Referring to FIG. 3A, the finish layers 80 include a second glaze coat 84 that covers the first glaze coat 82 and completely fills the wood grain impregnations 72. This helps provide the composite material 52 with a deeper, more authentic natural wood appearance. The second glaze coat 84 may be formed of any of the materials used to form the first glaze coat 82. The second glaze coat 84 may, for example, have a thickness of about 0.1-1.0 mils and may be thermal cured, air-dried, or UV cured.

The first glaze coat 82 and, if included, the second glaze coat 84, give the wood appearance portion 50 the desired stained wood tone. The composite material 52 and/or isolator base coat accepts or absorbs the stain or pigments in the glaze coat(s). This gives the portions of the glaze coat(s) on the surface 74 of the composite portion 14 a stained natural wood appearance. The portions of the glaze coat(s) that fill the wood grain impregnations 72 have a thickness that is greater than the portions of the glaze coats on the surface 74 of the composite portion 14. Typically, the glaze coat 82 is wiped off the surface 75. This highlights the wood grain 70, by providing a darkened appearance similar to that achieved with the wood grain of natural wood when a pigment or stain is applied.

The finish layers 80 may also include another isolator and/or build coat 86 disposed after the glaze coat 82. The isolator and/or build coat 86 is clear or dyed and may be made of the same materials as the isolator coat 64. This coat may also contain pearlescent pigments, mica and small levels of metallic pigments. The isolator coat 86 may, for example, have a thickness of about 0.5-1.0 mils and may be thermal cured, UV cured, or air dried. It may be tinted or clear and can contain pearlescent pigments.

The finish layers 80 may also include another clear isolator coat 90 disposed on the second glaze coat 84. The isolator coat 90 may, for example, have a thickness of about 0.5 mils and may be thermal cured. This coat may also contain pearlescent pigments, mica and small levels of metallic pigments.

The finish layers 80 may also include one or more clear or tinted coats 92. This coat may also contain pearlescent pigments, mica and small levels of metallic pigments.

In the illustrated embodiment, there are two clear coats 92. The clear coats 92 may, for example, be formed from a polyester, urethane, or other suitable material, having a thicknesses of about 3.0-7.5 mils, and may be thermal cured, UV cured, or air dried. More particularly, the first applied clear coat 92 may be partially UV cured (“gel cured”) and, after the second clear coat is applied, both clear coats may be fully UV cured.

The finish layers 80 may further include one or more high-gloss clear or tinted coats 94. In the illustrated embodiment, there are two top coats 94. As an example, the top coats 94 may be formed from a polyurethane, polyester, or other suitable material, and have thicknesses of about 1.0-3.0 mils, and may be UV cured, thermal cured, or air dried. More particularly, the first applied top coat 94 may be partially UV cured (“gel cured”) and, after the second top coat is applied, both top coats may be fully UV cured. After the clear coat 94 has dried, buffing may be desirable.

To manufacture the steering wheel 30, the substrate 42 and the composite material 52 are molded on the armature 32. FIG. 4 illustrates an injection molding apparatus 104 that may be used to mold the substrate 42 and composite portion 52. Referring to FIG. 4, resin pellets 100 of the material used to form the substrate 42 are loaded into a hopper 102 of the injection molding apparatus 104. Other ingredients or additives, such as chemical foaming agents, if utilized, are also loaded in a separate hopper (not shown) or in the hopper 102 and mixed with the resin 100. From the hopper 102, the pellets 100 are fed into an injection molding machine 110 that melts the pellets and injects the heated melt 120 into a mold 112. The injection molding machine 110 may be of any type, such as a heated, screw-fed injection molding machine or a ram-fed injection molding machine.

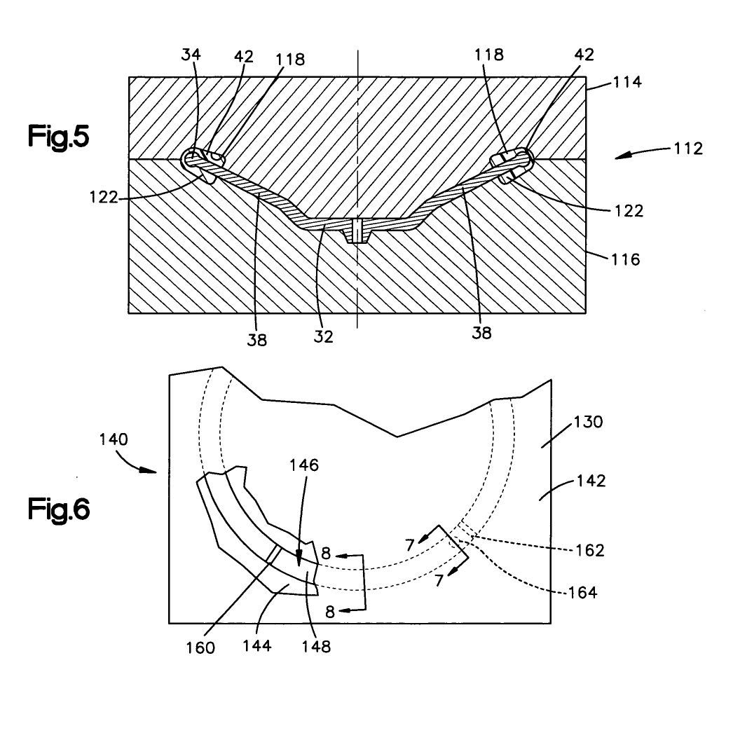

Referring to FIG. 5, the mold 112 includes a first half 114 and a second half 116. The first and second mold halves 114 and 116 define a mold cavity 118 in which the steering wheel armature 32 is received. The mold cavity 118 has portions that form a close fit with the armature 32 so as to prevent deposition of the heated melt 120 on certain portions of the armature. The mold cavity 118 also has portions that form a clearance with the armature 32, thus defining a mold space 122 for receiving heated melt 120 for deposition on the armature 32. The mold 112 further includes at least one sprue gate or barrel (not shown) through which the heated melt 120 from the injection molding machine 110 may be injected into the mold cavity 118. The heated melt 120 fills the mold space 122 in the mold cavity 118, thus forming the substrate 42 on the armature 32.

The steering wheel armature 32 on which the substrate 42 has been molded is then placed into a second mold 140 to mold the composite material 52 onto the rim portion 34 of the armature 32. As shown in FIG. 4, the second mold 140 may be used in conjunction with an injection molding machine 110 similar or identical to that described above as being used to form the substrate 42 on the steering wheel armature 32. Resin pellets 150 of the composite material 52 are loaded into the hopper 102 along with any desired additives. From the hopper 102, the pellets 150 are fed into the injection molding machine 110 which melts the pellets and injects the heated melt into the mold 140.

Referring to FIG. 6, the mold 140 includes a first or upper half 142 that is partially cut-away to reveal a second or lower half 144. The first and second mold halves 142 and 144 define a mold cavity 146 for receiving the steering wheel armature 32 on which the substrate 42 has been molded as described above. The mold cavity 146 has portions that form a close fit with the armature 32 and substrate 42 so as to prevent deposition of the heated melt on certain portions of the armature or substrate. The mold cavity 146 also has portions that form a clearance with the armature 32, thus defining a mold space 148 for receiving heated melt for deposition on the arcuate segment 58 of the armature 32.

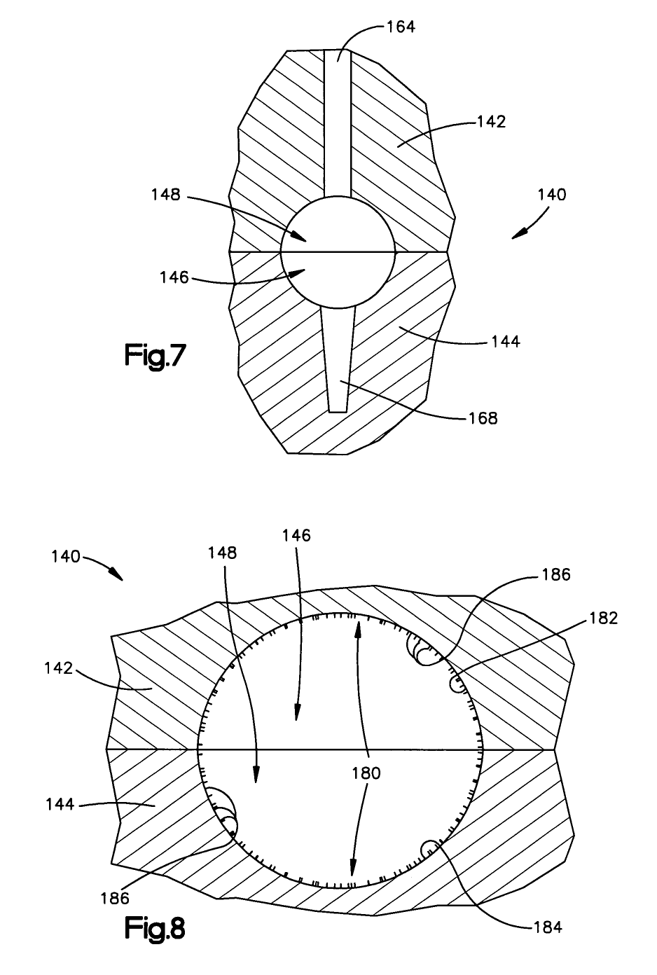

The mold 140 also includes hard seals 160 and 162 at opposite ends of the mold space 148. The seals 160 and 162 isolate the heated melt from the substrate 42. The mold 140 further includes an aperture 164 (FIG. 7), located in close proximity to the hard seal 162, for receiving a sprue gate or barrel (not shown) of the injection molding machine 110. The mold 110 may include a gas trap 168 for helping to prevent bubbles from forming in the composite material 52 when molded onto the rim portion 34.

Referring to FIG. 8, the mold space 148 is defined by a wall portion 182 of the first mold half 142 and a wall portion 184 of the second mold half 144. Wood grain grooves 186 formed on the wall portions 182 and 184 help define a wood grain pattern 180 of the wall portions. The grooves 186 are configured and arranged to resemble typical wood grain patterns of desired natural woods, such as pine, oak, walnut, eucalyptus, birch, maple, burl, or mahogany. The grooves 186 form the wood grain impregnations 72 on an outer surface of the composite material 52 when formed in the mold 140.

The sprue gate directs the heated melt from the injection molding machine 110 into the mold cavity 118 and should be located on a non class A surface. The heated melt fills the mold space 148 and surrounds the arcuate segment 58 of the rim portion 34. The melt is then cooled and the steering wheel armature 32, on which the composite material 52 has been molded, is removed from the mold 140.

The finish layers 80 are then applied to the outer surface 74 of the composite material 52 in a conventional manner. For example, the finish layers 80 of the embodiment illustrated in FIG. 3A may be applied to the composite material 52 by first lightly sanding the outer surface 74 (e.g., with sandpaper or an abrasive cleaning pad) and cleaning the outer surface with a solvent, such as acetone or isopropyl alcohol. Next, the isolator base coat 64 is applied via spray application, cured, sanded, and cleaned. Next, the first glaze coat 82 is applied by wiping or brushing the glaze onto the outer surface 74 and wiping off the excess glaze after a predetermined time period. Once the first glaze coat 82 is dried, the first isolator coat 86 is applied via spray application, cured, sanded, and cleaned. These steps are repeated to apply the second glaze coat 84, if desired, and second isolator coat 90. Next, the build or clear coats 92 are applied via spray application, with each coat being cleaned after drying/curing and prior to applying the next build coat. Next, the final coats 94 are applied via spray or dip application, with each coat being cleaned after curing and prior to applying the next top coat. Each of the clear coats 92, 94 can optionally be sanded before being cleaned. Alternatively, the clear coat can be applied in-mold using Kraus Maffei Technology. The final top coat 94 may be buffed.

From the above description of the invention, those skilled in the art will perceive improvements, changes and modifications. For example, the steering wheel, spokes, or composite article could be formed by a two shot co-injection molding process using just one injection molding apparatus. Such improvements, changes, and modifications within the skill of the art are intended to be covered by the appended claims.

Having described the invention, the following is: claimed:

1. A steering wheel comprising:
a steering wheel armature comprising at least one of a rim portion and a spoke portion; and
a composite portion formed by a composite material molded onto at least one of the rim portion and spoke portion, the composite material comprising a cellulose-based resin matrix material, the composite portion having an outer surface and wood grain impregnations formed on the outer surface and having a natural wood grain appearance.

2. The steering wheel recited in claim 1, wherein the composite portion is sufficient to accept wood stain.

3. The steering wheel recited in claim 1, wherein the composite portion is sufficient to accept at least one of a wood stain, glaze and pre-treatment material comprising at least one of an adhesion promotion material, fluorination, flame coating, and plasma treatment.

4. The steering wheel recited in claim 1, wherein at least one of the rim portion and the spoke portion is insert molded in the composite material.

5. The steering wheel recited in claim 1, further comprising an outer finish portion disposed on the outer surface of the composite portion, the outer finish portion comprising at least one coating layer that covers the outer surface and darkens the wood grain impregnations to help produce the natural wood grain appearance.

6. The steering wheel recited in claim 1, further comprising at least one of a wood stain and a glaze applied to the outer surface of the composite portion to provide the composite portion with a stained natural wood appearance.

7. The steering wheel recited in claim 6, wherein at least one of the wood stain and the glaze at least partially fills the wood grain impregnations and provides the grooves with an appearance that is darkened with respect to the remainder of the stained outer surface.

8. The steering wheel recited in claim 1, further comprising a padding portion covering a portion of the rim portion, the padding portion comprising a substrate material molded onto the rim portion, the substrate material leaving an arcuate segment of the rim portion uncovered, the composite material being molded onto the arcuate segment of the rim portion.

9. The article recited in claim 8, wherein the arcuate segment of the rim portion is insert molded in composite material.

10. The steering wheel recited in claim 1, wherein the composite portion covers an arcuate segment of the rim portion.

11. The steering wheel recited in claim 1, wherein the composite material further comprises a polymer.

12. The steering wheel recited in claim 11, wherein the polymer comprises one of polypropylene, polypropylene copolymers, polyethylene, and polyvinyl chloride.

13. The steering wheel recited in claim 1, wherein the cellulose-based material comprises a cellulose-based wood material.

14. The steering wheel recited in claim 13, wherein the cellulose-based wood material comprises at least one of woodmeal and sawdust.

15. The steering wheel recited in claim 1, wherein the composite material comprises a resin comprising a cellulose-based wood material and one of polypropylene, polypropylene copolymers, polyethylene, and polyvinyl chloride.

16. An article with a surface adapted to be a class A surface in a vehicle, the article comprising:
a composite portion comprising a composite material, the composite material comprising a cellulose-based material in a weight percentage, the composite portion being sufficient to accept wood stain;
a core portion insert molded in the composite material, the composite portion having an outer surface and grooves molded in the outer surface, the grooves being configured to resemble a natural wood grain; and
a coating portion comprising at least one layer of at least one of a wood stain and a glaze disposed on the outer surface of the composite portion to give the composite portion a stained natural wood appearance.

17. The article recited in claim 16, wherein the at least one of the wood stain and the glaze at least partially fills the grooves, the thickness of the one of the wood stain and the glaze disposed in the grooves being greater than the thickness of the wood stain on the remainder of the outer surface of the composite portion.

18. The article recited in claim 16, wherein the wood stain disposed in the grooves provides the grooves with an appearance that is darkened with respect to the remainder of the stained outer surface of the composite portion.

19. A method of manufacturing a steering wheel comprising the steps of:
providing a mold having a mold cavity at least partially defined by the inner surface of the mold and grooves having a configuration resembling a natural wood grain;
providing a steering wheel armature;
positioning the steering wheel armature in the mold cavity; and
injecting a composite material into the mold cavity and onto a rim portion of the steering wheel armature, the composite material comprising a cellulose-based material, the grooves in the tool impregnating a wood grain configuration on the outer surface of the composite material in the configuration resembling a natural wood grain.

20. The method according to claim 19, further comprising the steps of:
removing the steering wheel armature from the mold cavity with the composite material molded on the rim portion; and
applying a coating to the outer surface of the composite material to provide the outer surface with a natural wood grain appearance, the coating comprising at least one of a wood stain and a glaze that stains the outer surface of the composite material and at least partially fills the grooves on the outer surface of the composite material to provide the composite material with a stained natural wood appearance.

21. An alternative molding process whereby the tool does not contain grooves and the natural wood grain design is not impregnated into the cellulose based resin, but is however applied using a faux finishing process to give the wood grain appearance.
